(19) United States
(12) Patent Application Publication
(10) Pub. No.: US 2004/0081331 A1
(43) Pub. Date: Apr. 29, 2004

(54) Electro-acoustic transducer having vibrating function and method of manufacturing the same

(76) Inventors: Kimihiro Ando, Mie (JP); Kenichi Ajiki, Mie (JP)

Correspondence Address: WENDEROTH, LIND & PONACK, L.L.P., 2033 K STREET N. W., SUITE 800, WASHINGTON, DC, 20006-1021, US

(21) Appl. No.: 10/380,281

(22) PCT Filed: Oct. 24, 2002
(86) PCT No.: PCT/JP02/11062

(51) Int. Cl. H04R 1/00; H04R 11/02; H04R 9/06

(52) U.S. Cl. 381/398; 381/412

(57) ABSTRACT

A mechanical resonance frequency of vibration section 13 of an electro-acoustic transducer having vibrating function is measured during assembly process and is compared with a predetermined mechanical resonance frequency. Based on a difference obtained by the comparison, one of an weight of weight 14 to be attached and a position for fixing the vibration section to frame 16 is determined. In accordance with the determination, the weight 14 for resonance frequency adjustment is attached to vibration section 13, or suspension 12 and frame 16 which have been provisionally fixed are fixed again. Thus the predetermined mechanical resonance frequency f₀ can be obtained steadily. As a result, the rectro-acoustic transducers having vibrating function with stabilized mechanical resonance frequency of the vibration section 13 can be produced.

### TECHNICAL FIELD

The present invention relates to an electro-acoustic transducer having vibrating function, and a method for manufacturing the transducer.

### BACKGROUND ART

A conventional electro-acoustic transducer having vibrating function (hereinafter referred to as a transducer) is disclosed in Japanese Patent Laid-Open Application No. 2000-153231. The conventional transducer is described referring to FIGS. 5A and 5B. FIG. 5A is a plan view, FIG. 5B is a cross sectional view.

Referring to FIGS. 5A and 5B, the transducer's voice coil 10a is fixed to a diaphragm 10. A magnetic circuit 11 comprises a magnetic circuit portion 11a which generates a driving power by flowing an electric current in voice coil 10a, and an weight portion 11b which is integrated with the magnetic circuit portion 11a. The weight portion 11b is added for the purpose of sensing vibration of vibration section 13, which will be referred to later. If a vibration section 13 generates sufficient vibration, the weight portion 11b can be omitted.

Magnetic circuit portion 11a and weight portion 11b are supported by a frame 16 via a suspension 12. Vibration section 13 comprises magnetic circuit 11 and suspension 12. Diaphragm 10 and voice coil 10a constitute a mechanical resonance circuit of acoustic section. Magnetic circuit 11 and suspension 12 constitute a mechanical resonance circuit of vibration section 13.

Weight portion 11b is a molded resin containing tantalum powder, suspension 12 and magnetic circuit portion 11a are integrated with the weight portion 11b through an insert molding process to provide a one-piece component. A baffle 17 is bonded with periphery of diaphragm 10, and attached to frame 16.

Now, operation of the above-configured electro-acoustic transducer having vibrating function is described below.

As voice coil 10a is disposed in a magnetic gap A of magnetic circuit portion 11a, when an AC current is applied, voice coil 10a generates a driving force. Since a weight of voice coil 10a is very small relative to that of magnetic circuit 11, magnetic circuit 11 does not vibrate at most of frequency ranges, while voice coil 10a alone vibrates. Thus, diaphragm 10 is vibrated by voice coil 10a to generate sounds at most of frequency ranges.

Since vibration section 13 is for sensing the vibration by a human body, a mechanical resonance frequency of vibration section 13 is set at a certain frequency that is lower than that of the acoustic section. Mechanical impedance of vibration section 13 becomes smallest at the mechanical resonance frequency. Therefore, even with a small driving force, vibration section 13 can generate a vibration large enough to be sensed by the human body. Vibration force at this time is determined by a product of vibration section 13's weight (that is a weight of magnetic circuit 11, in an approximation) and acceleration of vibration section 13.

In the conventional transducer having vibration function operating in the above-described principle, the mechanical resonance circuit becomes to have a high resonance sharpness Q in order to vibrate a vibration section 13 which has a large mass. As a result, vibration section 13's mechanical resonance frequency disperses largely against resonance frequency signals delivered to voice coil 10a from outside for vibrating vibration section 13. This dispersion leads to problematical dispersion of vibrating force. The dispersion in mechanical resonance frequency is caused by weight dispersion of vibration section 13, dispersion in material thickness, width, Young's modulus, and the like of suspension 12, and supporting position dispersion of suspension 12 and other factors.

The present invention addresses the above problems and provides an electro-acoustic transducer having vibrating function, where the mechanical resonance frequency of the vibration section can be adjusted at low cost, and the dispersion in vibrating force is reduced.

### SUMMARY OF THE INVENTION

An electro-acoustic transducer having vibrating function in the present invention comprises a diaphragm, a voice coil fixed to the diaphragm, a magnetic circuit provided with a magnetic gap in which the voice coil is inserted, and a vibration section provided with suspensions for connecting the magnetic circuit to a frame. Weight(s) for adjusting a resonance frequency of the vibration section is(are) attached to the vibration section based on a result of measurement performed during a course of production process, or the frame and the suspensions are connected at a plurality of connecting positions based on the above result. The weight(s) for adjusting the resonance frequency in the present invention is(are) attached so that the weight(s) does not cause shift of the center of gravity of the vibration section.

### BRIEF DESCRIPTION OF THE DRAWINGS

FIG. 1 shows plan view of a vibration section (before a diaphragm is attached) of a transducer in accordance with an exemplary embodiment of the present invention.

FIG. 2 shows plan view of a vibration section (before a diaphragm is attached) of a transducer in accordance with another exemplary embodiment.

FIG. 3 is a cross sectional view showing a welding portion of the suspension and the frame.

FIG. 4 is a plan view showing a welding portion of the suspension and the frame in another exemplary embodiment.

FIG. 5A is plan view of a conventional transducer.

FIG. 5B is a cross sectional view of the conventional transducer.

### DESCRIPTION OF THE PREFERRED EMBODIMENTS

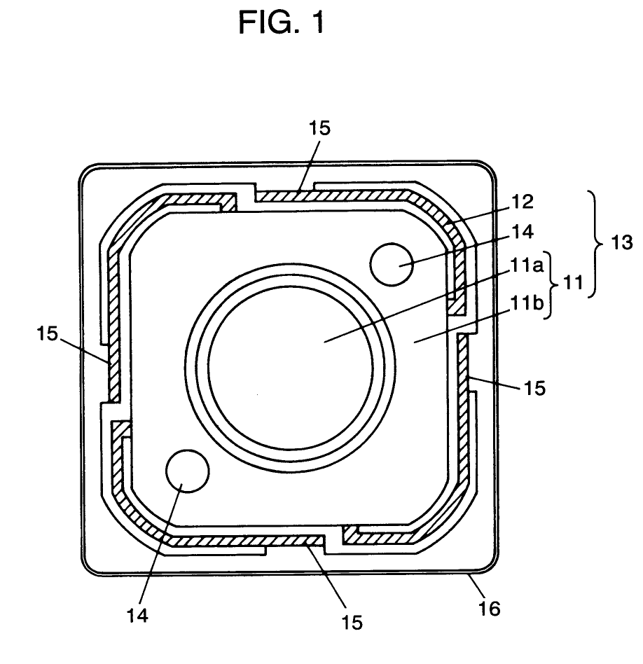

Electro-acoustic transducer having vibrating function of the present invention is described in the following in accordance with exemplary embodiments, referring to FIG. 1-FIG. 4. In the descriptions, those components identical to conventional technologies are represented by using the same reference numerals and the description is omitted.

First Embodiment

FIG. 1 shows a plan view of a vibration section, which is a key part of an electro-acoustic transducer having vibrating function in accordance with an exemplary embodiment of the present invention. The main point of difference from the conventional technology is that the transducer has weights for adjusting a resonance frequency attached to a weight portion.

Referring to FIG. 1, a magnetic circuit 11 comprises a magnetic circuit portion 11a and a weight portion 11b which does not function as a part of magnetic circuit practically. The magnetic circuit 11 and a suspension 12 (hatched) form a vibration section 13.

Fixing portions 15 between frame 16 and suspension 12 are provided at four places in a symmetric arrangement. Although in the present embodiment these are connected by adhesives, other method such as a caulking, a welding, a brazing and the like may be employed. Suspension 12 and magnetic circuit portion 11a are formed integrally when weight portion 11b is formed by resin molding.

Weight portion 11b is attached with weights 14 for adjusting mechanical resonance frequency at two places in order to adjust mechanical resonance frequency of vibration section 13. Weights 14 are aligned on a diagonal line passing through a center of gravity of magnetic circuit portion 11a and weight portion 11b. Therefore, the center of gravity after weights 14 are attached does not shift on a plane direction, remaining at the same position.

The position arrangement(s) for weight(s) 14 is(are) not necessarily be as described above, a number of the weight may be one or the number may be more than one, in so far as the weight(s) does not shift the center of gravity.

If the center of gravity shifts as a result of the positions of weight(s) 14, vibration section 13 is liable to cause a rolling motion when it vibrate.

Now, a process of manufacturing the transducer is described.

In the first place, magnetic circuit 11 is fixed to frame 16 via suspension 12 to form vibration section 13. Then, voice coil 10a attached to dummy diaphragm 10, for example, is inserted to the magnetic gap of magnetic circuit portion 11a, and dummy current is applied to voice coil 10a. Or, a mechanical resonance circuit of vibration section is vibrated by an external source. Through one of these operations, vibration section 13's mechanical resonance frequency is measured. The mechanical resonance frequency f₀ is calculated by the formula below:

f₀=1/2π\sqrt{mc} (Formula 1)

Mass (weight) m of the vibration section is measured previously, and then using the Formula 1, a value of weight 14 that should be attached to the vibration section for satisfying a predetermined resonance frequency can be calculated. The weight value is divided by a number of weight positions (two, in the present embodiment). Weights having the value are attached in respective positions by using adhesives or the like.

And then, real diaphragm 10 with voice coil 10a is attached to frame 16 with the voice coil 10a inserted in the magnetic gap of magnetic circuit 11. A transducer is thus produced.

The above-described manufacturing process can be carried out on an assembly line, which can further be automated. Thus the present invention enables highly efficient and stable production of transducers having vibrating function, with vibration section 13 having a predetermined resonance frequency.

In the present embodiment, the mechanical resonance frequency of vibration section 13 is adjusted by adding weights 14. Therefore, the weight of vibration section 13 before attaching weights 14 has to be set to be slightly lighter than designed. This means that the mechanical resonance frequency is higher than a predetermined frequency. By so doing, the mechanical resonance frequency can be adjusted rather easily during assembly process to keep within an allowance range of the predetermined mechanical resonance frequency.

In the present embodiment, descriptions are based on a case where the initial mechanical resonance frequency is measured in the course of assembling the transducer, and then weights 14 for adjustment are attached in accordance with the measured mechanical resonance frequency. Besides the above-described way of adjusting, there can be an alternative procedure. That is, weights 14 for adjustment can be attached through an opening provided in frame 16 at a place corresponding to a reverse side of weight portion 11b. In the latter procedure, the resonance frequency adjustment can be made even after a transducer is finished, without using a dummy diaphragm. A further improvement of productivity can also be expected in the latter procedure.

Second Embodiment

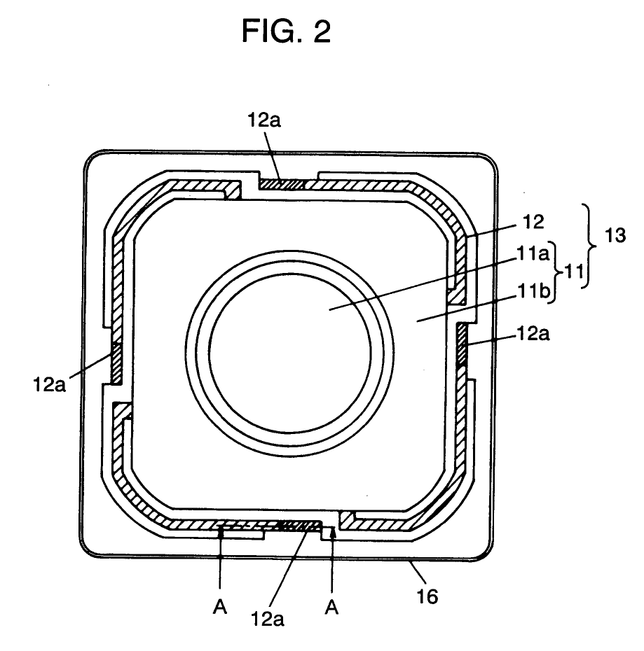

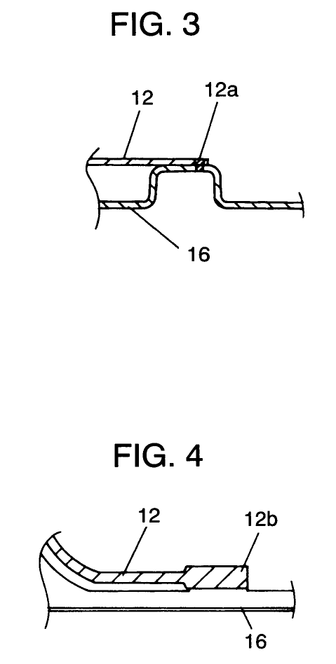

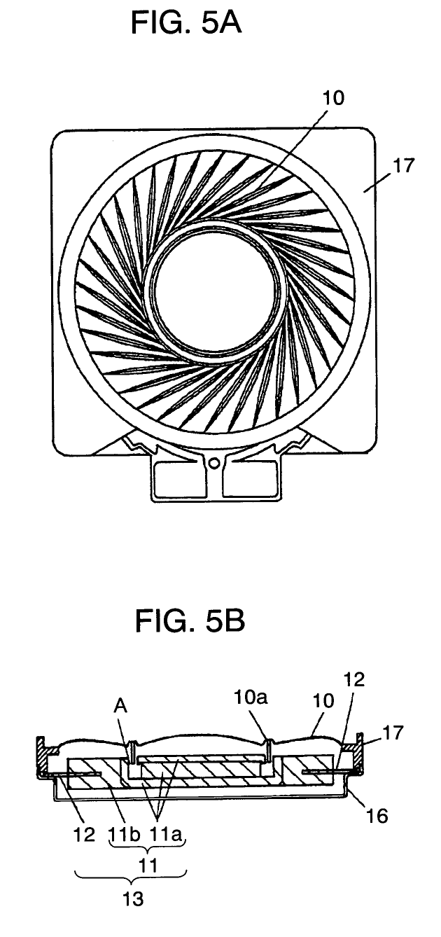

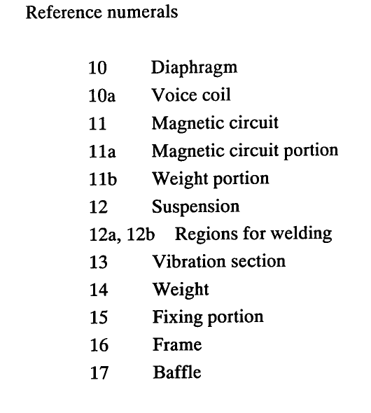

FIG. 2 is a plan view of a vibration section of a transducer in a second exemplary embodiment. FIG. 3 is a cross sectional view of a welded portion of the vibration section. FIG. 4 is a plan view showing a welded portion of a vibration section of a modified exemplary embodiment.

Only the point of difference from the conventional technology is described with reference to FIG. 2. Suspension 12 and frame 16 in the present embodiment are connected by welding. Furthermore, regions 12a for welding are provided at four places each having a long length along the circumference direction of suspension 12 around magnetic circuit 11.

Like in the first embodiment, a mechanical resonance circuit of vibration section 13 is completed, which is a half-finished stage before diaphragm 10 is attached. So, the mechanical resonance frequency can be measured. Therefore, the same procedure can be performed as the first embodiment. Namely, a process for obtaining a predetermined mechanical resonance frequency is performed based on a difference between a mechanical resonance frequency measured by attaching dummy diaphragm 10 with voice coil 10a and the predetermined mechanical resonance frequency. In the present embodiment, welding positions between suspension 12 and frame 16 are calculated for obtaining the predetermined mechanical resonance frequency. In practice, suspension 12 and frame 16 are provisionally fixed together by welding, and then these are welded again at a position obtained by the calculation to change effective length of suspension 12 supporting the vibration section 13. The predetermined mechanical resonance frequency is thus obtained.

Since the mechanical resonance frequency is adjusted to the predetermined value by adding an welding place between suspension 12 and frame 16, the provisional welding position should be determined so that a mechanical resonance frequency being lower than the predetermined value. Describing practically, the provisional welding should be performed to leave a longer support for suspension 12, and then welding is performed again at a precise point after the mechanical resonance frequency is measured to obtain the predetermined mechanical resonance frequency. By so doing, the mechanical resonance frequency can be adjusted rather easily during assembly process to keep within an allowance range of the predetermined mechanical resonance frequency.

In the above description, suspension 12 and frame 16 are finally welded at a stage where vibration section 13 is completed, but it is a stage still half-finished as a transducer. Besides the above-described way of adjusting, there can be an alternative procedure. That is, a final welding of suspension 12 and frame 16 can be performed through an opening provided in frame 16. In the latter procedure, the resonance frequency can be adjusted to the predetermined mechanical resonance frequency even after diaphragm 10 is attached and a appearance of the transducer is finished. In this procedure, the operation of attaching and detaching the dummy diaphragm is eliminated and an improved productivity can be expected during production.

FIG. 4 shows a modified example of the present embodiment. Though, suspension 12 in the present embodiment is extending in the circumference direction to form a region 12a for welding, that in the modified example is expanded also in the radius direction to widen the region 12b for welding.

In a case where a welding position for obtaining a predetermined mechanical resonance frequency is very close to an initial welding position, the region 12b for welding which has been expanded also in the width direction provides a stable welding condition. For example, for a transducer of 20 mm square whose mechanical resonance frequency is approximately 120 Hz, a subtle adjustment of about 0.2-0.4 mm for shifting the resonance frequency by 2 Hz is required. A welding for such an adjustment might overlap on the provisional welding. The greater width of region 12b for welding wider than other part of the suspension makes small influence to a compliance of the whole suspension 12b. This allows to set a large shift amount for the welding position. Thus, the configuration is effective to avoid overlapped welding.

The above descriptions have been based on a structure where suspension 12 is integrated with weight portion 11b by a resin molding to form a single component, and the welding is made only between frame 16 and suspension 12. However, the present invention is not limited to the above-described configuration. The weight portion 11b may be made of a metal such as iron that can be welded so that it can be welded with suspension 12. In this case, the adjustment to the predetermined mechanical resonance frequency can be conducted between suspension 12 and weight portion 11b. However, it may be easier and more efficient to conduct the welding operation between frame 16 and suspension 12 with respect to productivity.

The foregoing descriptions on respective embodiments have been based on a procedure, where a mechanical resonance frequency of individual vibration section of a transducer is measured after it is attached to a frame, and a difference from a predetermined mechanical resonance frequency is used for obtaining the predetermined mechanical resonance frequency. However, when the magnetic circuits, the suspensions and the frames are available in a very steady condition, an unitized vibration sections integrated with the magnetic circuit, the weight portion and the suspension can be supplied. In this case, at least one out of one lot of the supplied vibration section is(are) sampled, and the sample is attached to a frame in the same manner as in the above embodiments to determine an weight for resonance frequency adjustment, or a location shift for the welding. And production of electro-acoustic transducers having vibrating function may be performed in accordance with the determinations made in the above-described sampling process until new variation factor arises.

Thus, an individual measurement for each of a transducer conducted in the process of the production of the electro-acoustic transducer having vibrating function for the purpose of obtaining a predetermined mechanical resonance frequency, the determination of an weight for resonance frequency adjustment and the determination of welding position can be eliminated. This contributes to a substantial improvement of productivity.

Namely, in a state where the supply conditions influential to the variation of resonance frequency, such as a suspension material thickness, weight of magnetic circuit portion or the like are very stable, excluding the typical lot-to-lot variations, the above-described production process by the sampling measurement leads to a further efficient production.

### INDUSTRIAL APPLICABILITY

In a production of the electro-acoustic transducers having vibrating function, the mechanical resonance frequency of vibrating section can be stabilized in an efficient manner in accordance with the present invention. Thus the present invention provides a stable quality electro-acoustic transducers having vibrating function at a low cost, and provide a great influence in the industry.

1. An electro-acoustic transducer having vibrating function comprising:
a frame;
a diaphragm at least an outer periphery thereof being fixed to said frame;
a voice coil fixed to said diaphragm;
a magnetic circuit provided with a magnetic gap in which said voice coil is inserted; and
a vibration section provided with a suspension for fixing said magnetic circuit to said frame;
wherein, said vibration section is provided with an weight for adjusting a resonance frequency.

2. The electro-acoustic transducer having vibrating function of claim 1, wherein said weight for adjusting the resonance frequency is attached to a position where a center of gravity of said vibration section does not shift.

3. An electro-acoustic transducer having vibrating function comprising:
a frame;
a diaphragm at least an outer periphery thereof being fixed to said frame;
a voice coil fixed to said diaphragm;
a magnetic circuit provided with a magnetic gap in which said voice coil is inserted; and
a vibration section provided with a suspension for fixing said magnetic circuit to said frame;
wherein, at least one of a fixing portion of said frame and said suspension and a fixing portion of said magnetic circuit and said suspension is provided with an area enough for selecting a fixing position.

4. The electro-acoustic transducer having vibrating function of claim 3, wherein said fixing portion is fixed by welding.

5. A method of manufacturing an electro-acoustic transducer having vibrating function, said electro-acoustic transducer comprising:
a frame;
a diaphragm at least an outer periphery thereof being fixed to said frame;
a voice coil fixed to said diaphragm;
a magnetic circuit provided with a magnetic gap in which said voice coil is inserted; and
a vibration section provided with a suspension for fixting said magnetic circuit to said frame,
wherein said method further comprising the steps of:
measuring resonance frequency of a mechanical resonance circuit; and
adjusting said resonance frequency based on a measured resonance frequency and a predetermined resonance frequency.

6. The method of manufacturing an electro-acoustic transducer having vibrating function of claim 5, wherein said adjusting step further comprising:
determining an weight for adjusting resonance frequency based on said measured resonance frequency and said predetermined resonance frequency; and
attaching said weight for adjusting to said vibration section.

7. The method of manufacturing an electro-acoustic transducer having vibrating function of claim 6, wherein said attaching said weight for adjusting resonance frequency to said vibration section is conducted after said vibration section was attached to said frame.

8. The method of manufacturing an electro-acoustic transducer having vibrating function of claim 6, wherein said attaching said weight for adjusting resonance frequency to said vibration section is conducted after said electro-acoustic transducer is finished in appearance.

9. The method of manufacturing an electro-acoustic transducer having vibrating function of claim 6, wherein an weight of said mechanical resonance circuit of said vibration section is set so that said mechanical resonance circuit has a resonance frequency higher than said predetermined resonance frequency.

10. The method of manufacturing an electro-acoustic transducer having vibrating function of claim 6, wherein an weight of said weight for adjusting for vibration sections in a same lot is determined based on a resonance frequency measurement of at least one set of mechanical resonance circuit fixed to said frame, said at least one set of mechanical resonance circuit being sampled from said lot.

11. The method of manufacturing an electro-acoustic transducer having vibrating function of claim 5, wherein said adjusting step further comprising the steps of:
determining a position for fixing again at least one of a fixing position between said frame and said suspension and a fixing position between said magnetic circuit and said suspension, said at least one of a fixing positions being provisionally fixed, and
fixing again at said determined position for fixing.

12. The method of manufacturing an electro-acoustic transducer having vibrating function of claim 11, wherein said fixing at determined position is conducted by one of welding and adhesives.

13. The method of manufacturing an electro-acoustic transducer having vibrating function of claim 11, wherein said fixing at determined position is conducted after said vibration section was assembled to said frame.

14. The method of manufacturing an electro-acoustic transducer having vibrating function of claim 11, wherein said fixing at determined position is conducted after an appearance of said electro-acoustic transducer is finished.

15. The method of manufacturing an electro-acoustic transducer having vibrating function of claim 11, wherein said frame, said suspension and said magnetic circuit are provisionally fixed, prior to said adjusting process, so that a mechanical resonance circuit has a resonance frequency lower than a predetermined resonance frequency of said mechanical resonance circuit.

16. The method of manufacturing an electro-acoustic transducer having vibrating function of claim 11, wherein frames, suspensions and magnetic circuits from same lots are fixed at positions determined by at least one set of frame, suspension and magnetic circuit sampled from said lots.
